(19) United States
(12) Patent Application Publication
(10) Pub. No.: US 2016/0079616 A1
(43) Pub. Date: Mar. 17, 2016

(54) HOLLOW FIBER MODULE

(71) Applicant: KOLON INDUSTRIES, INC., Gwacheon-si, Gyeonggi-do (KR)

(72) Inventors: Jin Hyung LEE, Yongin-si (KR); Kyoung Ju KIM, Yongin-si (KR); Young Seok OH, Yongin-si (KR); Moo Seok LEE, Seoul (KR)

(73) Assignee: KOLON INDUSTRIES, INC., Gwacheon-si, Gyeonggi-do (KR)

(21) Appl. No.: 14/784,055

(22) PCT Filed: Apr. 14, 2014
(86) PCT No.: PCT/KR2014/003177

§ 371 Date: Oct. 13, 2015

(30) Foreign Application Priority Data
Apr. 18, 2013 (KR) 10-2013-0042826

(51) Int. Cl. H01M 8/04; B01D 63/02; C02F 1/44; B01D 53/22

(52) U.S. Cl. CPC H01M 8/04149; B01D 53/228; B01D 63/02; C02F 1/44; B01D 2053/224; B01D 2313/04; B01D 2319/04

(57) ABSTRACT

A hollow fiber module is disclosed. The hollow fiber module in various aspects of the present invention may include: a housing, and a hollow fiber bundle mounted in the housing and having a fluid penetration distance ranged from 10 to 200 mm. The fluid penetration distance means the shortest distance from the outmost hollow fiber in a cross-section of the hollow fiber bundle to the hollow fiber existing at the center in the cross-section of the hollow fiber bundle. In accordance with various embodiments of the present invention, the hollow fiber module may maximize the fluid delivery efficiency by improving the flow uniformity of the fluid flowing the outside of the hollow fibers. In addition, the hollow fiber module may minimize the additional usage of the hollow fibers, and thus the cost and the size of the hollow fiber module may be reduced.

### TECHNICAL FIELD

The present invention relates to a hollow fiber module. More particularly, the present invention relates to a hollow fiber module maximizing the fluid delivery efficiency by improving the flow uniformity of the fluid flowing the outside of the hollow fibers, and minimizing the additional usage of the hollow fibers, so as to reduce the cost and the size of the hollow fiber module.

### BACKGROUND ART

A fuel cell is defined as an electricity-generating cell that generates electricity through combination of hydrogen and oxygen. Unlike general cells such as dry cells, storage cells and the like, fuel cells have advantages in that they can keep generating electricity for as long as hydrogen and oxygen are supplied, and are free from heat loss and thus have about twice the efficiency of internal combustion engines. In addition, since fuel cells directly convert chemical energy, generated by combination of hydrogen and oxygen, to electrical energy, they release almost no contaminants. Accordingly, fuel cells have other advantages of environmental friendliness and the ability to reduce concerns about depletion of resources in accordance with an increase in energy consumption.

Based on the type of electrolyte used, fuel cells are largely classified into polymer electrolyte membrane fuel cells (PEMFCs), phosphoric acid fuel cells (PAFCs), molten carbonate fuel cells (MCFCs), solid oxide fuel cells (SOFCs), alkaline fuel cells (AFCs) and the like. These various types of fuel cells essentially operate on the same principle, but are different in terms of the type of fuel used, operation temperature, catalyst, electrolyte and the like. Of these, polymer electrolyte fuel cells are known to be the most promising in the fields of transport systems as well as small-scale stationary electricity-generators, because they operate at lower temperatures and are capable of realizing miniaturization due to their higher power density, as compared to other fuel cells.

One of the most important factors in improving the performance of polymer electrolyte fuel cells is to maintain moisture content in the polymer electrolyte membrane of membrane electrode assembly by providing moisture in an amount not less than a predetermined level. This is the reason that polymer electrolyte membranes show a rapid decrease in electricity-generation efficiency, when dried.

Methods for humidifying polymer electrolyte membranes include 1) a bubbler humidification method that supplies moisture by filling a internal pressure vessel with water and passing a target gas through a diffuser, 2) a direct injection method that supplies moisture by calculating a moisture supply amount required for the reaction of fuel cells and directly supplying the amount of moisture through a solenoid valve to a gas flow pipe, 3) a humidifying-membrane method that supplies moisture to a gas flow layer using a polymeric separation membrane, and the like. Of these, the humidifying-membrane method, which humidifies a polymer electrolyte membrane by supplying water vapor to a gas provided to the polymeric electrolyte membrane using a membrane that selectively permeates water vapor contained in an exhaust gas, is highly advantageous in that a humidifier can be light-weight and miniaturized.

The selective permeation membrane used for the humidification membrane method is preferably a hollow fiber membrane which has a high index of permeation area per unit volume in case of module formation. That is, the use of a hollow fiber membrane for production of humidifiers has advantages in that fuel cells can be sufficiently humidified even with a small amount due to the possibility of high-integration of the hollow fiber membrane with a wide contact surface area, inexpensive materials are available, and moisture and heat contained in an unreacted hot gas discharged from fuel cells can be recovered and then recycled through the humidifier.

However, the humidification membrane using the hollow fiber may include a greater number of the hollow fibers in order to increase the capacity of it. In this case, the size of the humidification membrane become large unnecessarily since the usage efficiency of the hollow fibers is dramatically decreased. That is, the fluid flowing the outside of the hollow fibers could not penetrate the thickened hollow fiber bundle, and thus the fluid could not flow uniformly.

### CITATION LIST

### Patent Literature

(Patent document 0001) Korean Patent Laid-Open Publication No. 10-2009-0013304, 2009 Feb. 5

(Patent document 0002) Korean Patent Laid-Open Publication No. 10-2009-0057773, 2009 Jun. 8

(Patent document 0003) Korean Patent Laid-Open Publication No. 10-2009-0128005, 2009 Dec. 15

(Patent document 0004) Korean Patent Laid-Open Publication No. 10-2010-0108092, 2010 Oct. 6

(Patent document 0005) Korean Patent Laid-Open Publication No. 10-2010-0131631, 2010 Dec. 16

(Patent document 0006) Korean Patent Laid-Open Publication No. 10-2011-0001022, 2011 Jan. 6

(Patent document 0007) Korean Patent Laid-Open Publication No. 10-2011-0006122, 2011 Jan. 20

(Patent document 0008) Korean Patent Laid-Open Publication No. 10-2011-0006128, 2011 Jan. 20

(Patent document 0009) Korean Patent Laid-Open Publication No. 10-2011-0021217, 2011 Mar. 4

(Patent document 0010) Korean Patent Laid-Open Publication No. 10-2011-0026696, 2011 Mar. 16

(Patent document 0011) Korean Patent Laid-Open Publication No. 10-2011-0063366, 2011 Jun. 10

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a hollow fiber module having advantages of maximizing the fluid delivery efficiency by improving the flow uniformity of the fluid flowing the outside of the hollow fibers, and minimizing the additional usage of the hollow fibers, so as to reduce the cost and the size of the hollow fiber module.

### Technical Solution

A hollow fiber module in various aspects of the present invention may include: a housing, and a hollow fiber bundle mounted in the housing and having a fluid penetration distance ranged from 10 to 200 mm. The fluid penetration distance means the shortest distance from the outmost hollow fiber in a cross-section of the hollow fiber bundle to the hollow fiber existing at the center in the cross-section of the hollow fiber bundle.

The ratio of the fluid penetration distance to the length of the hollow fiber bundle may be in the range of 5 to 100%.

The hollow fiber bundle may have a wide and flat shape.

The thickness of the hollow fiber bundle may be in the range of 20 to 400 mm.

The ratio of the thickness to the width may be in the range of 10 to 100%.

The hollow fiber bundle may comprise a plurality of the hollow fibers in the amount of 30 to 60 vol % relative to the total volume of the hollow fiber bundle.

The hollow fiber module may comprise the hollow fiber bundles and a barrier dividing the hollow fiber bundles.

The hollow fiber module may comprise a plurality of the barriers, and the barrier is disposed to surround each of the hollow fiber bundle.

The barrier may have through-holes.

The housing may have a circular or an angular cross-sectional shape.

The housing may be opened at both ends, and the housing may have an inlet port and an outlet port.

The hollow fiber module may further comprise a potting portion fixing an end portion of the hollow fiber bundle to the housing and coupled to an end portion of the housing so as to hermetically seal the housing.

The hollow fiber module may further comprise a cover coupled to an end portion of the housing and having a fluid port.

The hollow fiber module is any one selected from the group consisting of a gas separating module, a heat exchanging module, a humidifying module and a water-treatment module.

### Advantageous Effects

In accordance with various embodiments of the present invention, the hollow fiber module may maximize the fluid delivery efficiency by improving the flow uniformity of the fluid flowing the outside of the hollow fibers. In addition, the hollow fiber module may minimize the additional usage of the hollow fibers, and thus the cost and the size of the hollow fiber module may be reduced.

### DESCRIPTION OF DRAWINGS

The above and other objects, features and other advantages of the present invention will be more clearly understood from the following detailed description taken in conjunction with the accompanying drawings, in which:

FIG. 1 is a perspective view of a hollow fiber module according to the first exemplary embodiment of the present invention.

FIG. 2 is a perspective view of a hollow fiber module according to the second exemplary embodiment of the present invention.

FIG. 3 is a cross-sectional view taken along line A-A′ of FIG. 1.

FIG. 4 is a cross-sectional view of a conventional hollow fiber module.

FIG. 5 is a cross-sectional view taken along line B-B′ of FIG. 1.

FIG. 6 is a cross-sectional view taken along line B-B′ of FIG. 2.

### BEST MODE

Exemplary embodiments of the present invention will hereinafter be described in detail so as to be easily executed by a person of an ordinary skill in the art. However, the present invention will be realized in various embodiments and is not limited to the exemplary embodiments described herein.

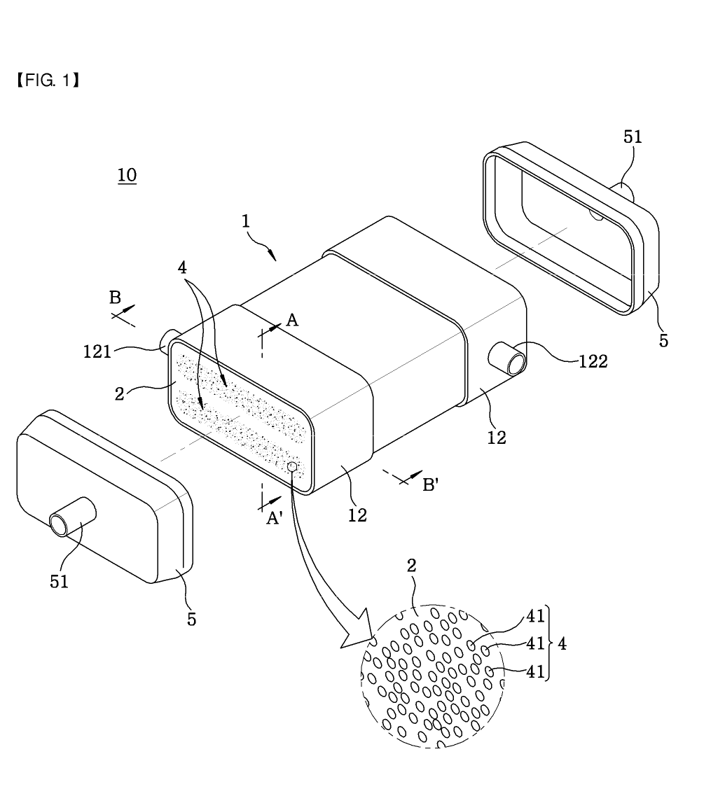

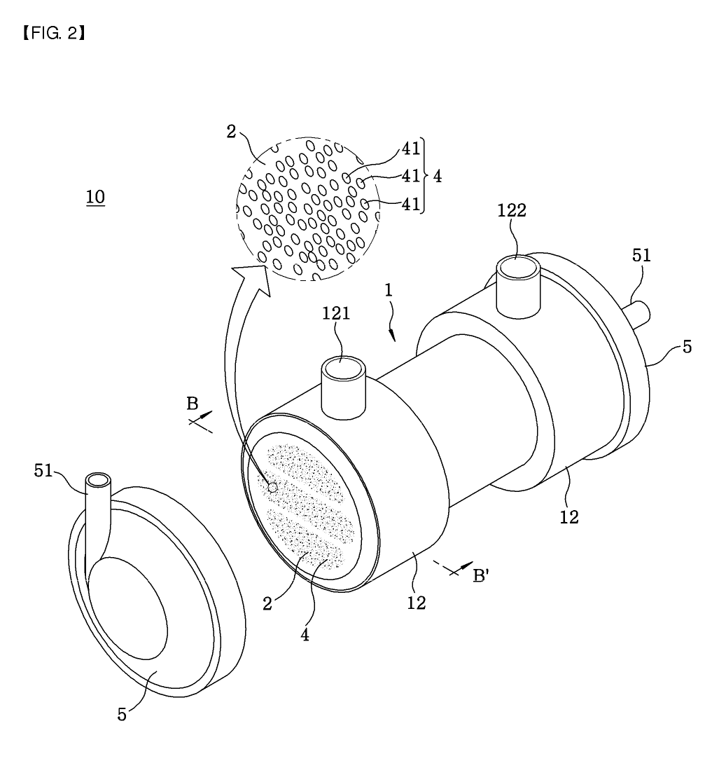

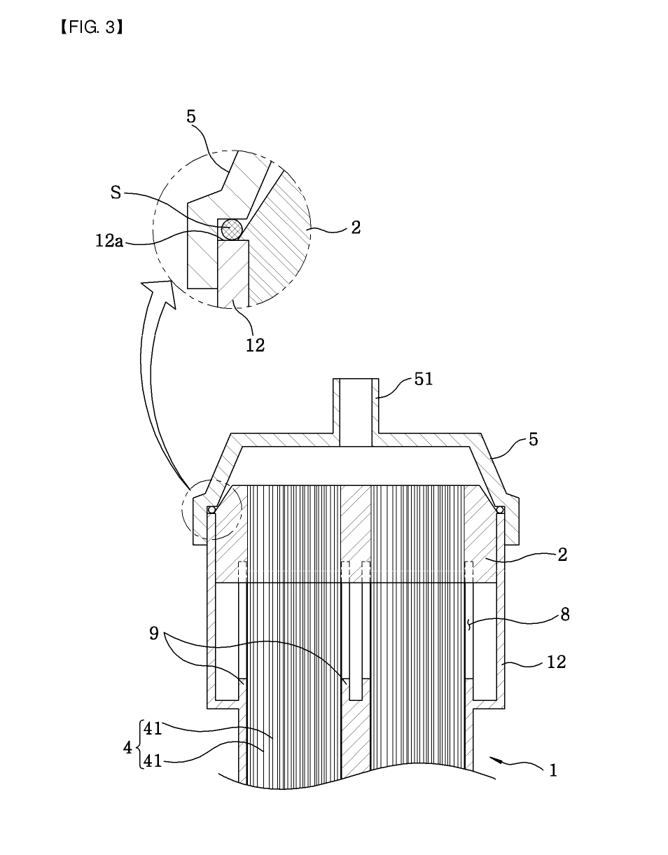

FIG. 1 is a perspective view of a hollow fiber module according to the first exemplary embodiment of the present invention, FIG. 2 is a perspective view of a hollow fiber module according to the second exemplary embodiment of the present invention, and FIG. 3 is a cross-sectional view taken along line A-A′ of FIG. 1. In the following description, the hollow fiber module, which is illustrated as an example of a humidifying module, will be described. Of course, the hollow fiber membrane is not limited to the humidifying module, and may be a gas separating module, a heat exchanging module or a water treating module.

Hereinafter, the hollow fiber module according to exemplary embodiments of the present invention will be described in detail with reference to the accompanying drawings. As shown in FIG. 1 to FIG. 3, the hollow fiber module 10 according to the first exemplary embodiment of the present invention includes a housing 1, a hollow fiber bundle 4, a pair of potting portions 2, and a pair of covers 5.

The housing 1 and the covers 5 form a shape of the hollow fiber module 10 and are made of hard plastic such as polycarbonate or metal. Furthermore, the housing 1 and the covers 5 may have a circular cross-sectional shape as shown in FIG. 1 or angular cross-sectional shape as shown in FIG. 2. The angular cross-sectional shape may be a tetragon, a square, a trapezoid, a parallelogram, a pentagon, a hexagon and the like. The corners of the angular cross-sectional shape may be rounded. The circular cross-sectional shape may be a circle or an oval.

The housing 1 is opened at both ends and includes an outer wall 12 so as to have a cylindrical shape substantially. The opened ends of the housing 1 is filled with the potting portion 2, and the potting portion 2 is enclosed by the outer wall 12 and is bonded to an interior circumference of an end portion of the outer wall 12. An inlet port 121 into which humidified fluid is flowed or an outlet port 122 from which the humidified fluid is discharged is formed at the outer wall 12.

The hollow fiber bundle 4 is mounted in the housing 1. A plurality of hollow fibers 41 are integrated in the hollow fiber bundle 4. The hollow fiber bundle 4 selectively passes the moisture. Material and structure of the hollow fiber 41 are well known to a person of an ordinary skill in the art, and thus detailed description of the hollow fiber 41 will be omitted in this specification.

The potting portion 2 connects end portions of the hollow fibers 41 with each other and fills gaps between the hollow fibers 41. In addition, the potting portion 2 is bonded to an interior circumference of an end portion of the outer wall 12 so as to hermetically seal the housing 1. The humidified fluid may flow inside the housing 1 hermetically sealed by the potting portions 2. Material and structure of the porting portion 2 are well known to a person of an ordinary skill in the art, and thus detailed description of the porting portion 2 will be omitted in this specification.

The cover 5 is coupled to the outer wall 12 of the housing 1 and includes a fluid port 51. An operating fluid flowing in through the fluid port 51 of the first cover 5 passes through a passage formed in the hollow fibers 41 and is discharged through the fluid port 41 of the second cover 5. When the operating fluid passes through the passage formed in the hollow fibers 41, the moisture is supplied to the operating fluid from the humidified fluid through the hollow fibers 41.

As shown in FIG. 3, the potting portion 2 may slope upward from the end 12a of the outer wall 12 toward the center of the housing 1. The hollow fibers 41 may penetrate the potting portion 2 so that the conduits of the hollow fibers 41 is exposed on the end of the potting portion 2. A sealing member S is interposed between the end 12a of the outer wall 12 and the cover 5. The cover 5 may be coupled to the housing 1 while press the sealing member S.

On the other hand, the hollow fiber bundle 4 have a fluid penetration distance ranged from 10 to 200 mm, preferably from 20 to 100 mm. Herein, the fluid penetration distance means the shortest distance from the outmost hollow fiber 41 in a cross-section of the hollow fiber bundle 4 to the hollow fiber 41 existing at the center in the cross-section of the hollow fiber bundle 4.

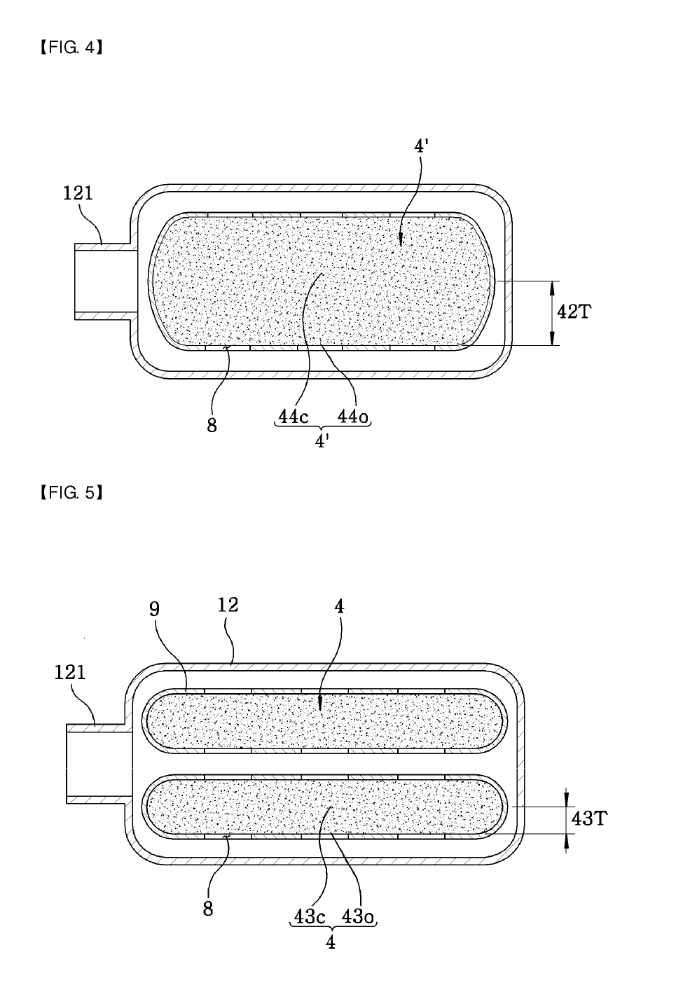

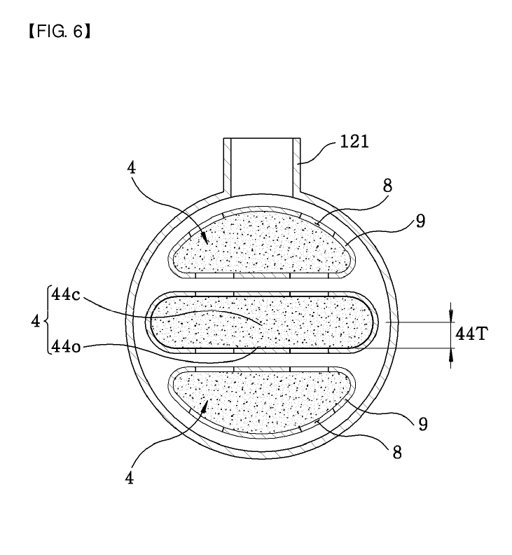

FIG. 4 is a cross-sectional view of a conventional hollow fiber module, FIG. 5 is a cross-sectional view taken along line B-B′ of FIG. 1, and FIG. 6 is a cross-sectional view taken along line B-B′ of FIG. 2. Hereinafter, the fluid penetration distance will be described with reference to FIG. 4 to FIG. 6.

The cross-section of the hollow fiber bundle 4 is an insection exposed by being taken along the perpendicular direction to the longitudinal direction. Therefore, the cross-sectional shape of the hollow fiber bundle 4 is formed by the aggregation of the hollow fibers 41.

The hollow fiber bundle 4 may have numberless cross-sections along the longitudinal direction. The cross-section for measuring the fluid penetration distance may be any one of the numberless cross-sections of the hollow fiber bundle 4. Representatively, the cross-section which exists at the end of the hollow fiber bundle 4, exposed by penetrating the potting portion 2, is used for measuring the fluid penetration distance.

Furthermore, the outmost hollow fiber 41 in the cross-section of the hollow fiber bundle 4 may exist in the surface of the hollow fiber bundle 4. The center in the cross-section of the hollow fiber bundle 4 means the center of gravity. If there is no hollow fiber 41 in the center of gravity, the hollow fiber 41 existing at the center in the cross-section of the hollow fiber bundle 4 is the closest hollow fiber 41 to the center of gravity.

As shown FIG. 4, in case of the conventional hollow fiber bundle 4′, the shortest distance 42T from the outmost hollow fiber 42o in a cross-section of the hollow fiber bundle 4 to the hollow fiber 41c existing at the center in the cross-section of the hollow fiber bundle 4 exceeds 200 mm. Therefore, the fluid flowing the outside of the hollow fibers 41 could not penetrate the thickened hollow fiber bundle 4, and thus the fluid could not flow uniformly.

As shown FIG. 5 and FIG. 6, the shortest distance 43T, 44T from the outmost hollow fiber 43o, 44o in a cross-section of the hollow fiber bundle 4 to the hollow fiber 42c, 43c existing at the center in the cross-section of the hollow fiber bundle 4 ranges from 10 to 200 mm. If the fluid penetration distance 43T, 44T is in the range, the fluid flowing the outside of the hollow fibers 41 could easily penetrate the hollow fiber bundle 4, and thus the performance of the hollow fiber module 10 is maximized by improving the flow uniformly of the fluid. In addition, since the hollow fiber module 10 may include a smaller number of the hollow fibers 41 in order to increase the capacity of the hollow fiber module 10, the cost and the size of the hollow fiber module 10 may be reduced.

The ratio of the fluid penetration distance 43T, 44T to the length of the hollow fiber bundle 4 is in the range of 5 to 100%, preferably 10 to 60%. If the ratio is less than 5%, the thickness of the hollow fiber bundle 4 is too thin to include a sufficient number of the hollow fibers 41, and if the ratio exceeds 100%, the fluid flowing the outside of the hollow fibers 41 could not penetrate the thickened hollow fiber bundle 4, and thus the usage efficiency of the hollow fibers 41 is decreased.

The hollow fiber bundle 4 may have a wide and flat shape. The wide and flat shape is even along the longitudinal direction, its width is wide, and its thickness is thin. Herein, the width may be longer than the thickness.

The thickness of the hollow fiber bundle 4 is in the range of 20 to 400 mm, preferably 40 to 100 mm. If the thickness of the flat and wide hollow fiber 4 is in the range, the fluid flowing the outside of the hollow fibers 41 could easily penetrate the hollow fiber bundle 4, and thus the performance of the hollow fiber module 10 is maximized by improving the flow uniformly. In addition, since the hollow fiber module 10 may include a smaller number of the hollow fibers 41 in order to increase the capacity of the hollow fiber module 10, the cost and the size of the hollow fiber module 10 may be reduced.

The ratio of the thickness to the width is in the range of 10 to 100%, preferably 20 to 60%. If the ratio of the thickness to the width is less than 10%, it becomes difficult to induce the flow uniformity along the width direction, and thus the usage efficiency of the hollow fibers 41 is decreased, and if the ratio of the thickness to the width exceeds 100%, the thickness of the hollow fiber bundle 4 is too thin to include a sufficient number of the hollow fiber 41.

The hollow fiber bundle 4 may comprise the hollow fibers 41 in the amount of 30 to 60 vol % relative to the total volume of the hollow fiber bundle 4. If the amount of the hollow fibers 41 is less than 30 vol %, the hollow fiber bundle 4 could not sufficiently include the hollow fibers 41, so that the size of the hollow fiber module 10 become large unnecessarily, and if the amount of the hollow fibers 41 exceeds 60 vol %, the density of the hollow fibers 41 is so great that it become to difficult to manufacture the hollow fiber module 10, and the pressure drop caused by the fluid flowing the outside of the hollow fiber 41 become larger.

The hollow fiber module 10 may comprises a plurality of the hollow fiber bundles 4 and a barrier 9 dividing the hollow fiber bundles 4. Also, the barrier 9 has through-holes so that the humidified fluid passes the barrier 9 through the through-hole 8 and flows the outside of the hollow fibers 41.

In addition, the hollow fiber module 10 may further comprise a plurality of the barriers 9, and the barrier 9 is disposed to surround each of the hollow fiber bundle 4.

The operating fluid flowing in through the fluid port 51 of the first cover 5 passes through a passage formed in the hollow fibers 41 and is discharged through the fluid port 41 of the second cover 5. On the other hand, the humidified fluid flowing in through the inlet port 121 of the housing 1 passes the outside of the hollow fibers 41, and then the humidified fluid flows out through the outlet port 122 of the housing 1. While the operating fluid and the humidified fluid respectively flow the inside and the outside of the hollow fibers 41, the operating fluid and the humidified fluid exchange a heat or materials such as moisture.

Although the operating fluid flows the inside of the hollow fibers 41 and the humidified fluid flows the outside of the hollow fibers 41 according to one exemplary embodiment of the present invention, the operating fluid may flow the outside of the hollow fibers 41 and the humidified fluid may flow the inside of the hollow fibers 41 according to the other exemplary embodiment of the present invention. Also, the operating fluid and the humidified fluid may flow in an opposite direction to the above described direction, and the operating fluid and the humidified fluid may flow in an opposite direction each other.

### Examples

### Preparation of a Hollow Fiber Module

### Comparative Example

A hollow fiber bundle having 14,000 pieces of polysulfone hollow fibers (external diameter: 900 um, internal diameter: 800 um) were mounted in a housing (width: 250 mm, length: 250 mm, height: 500 mm). Herein, the fluid penetration distance was 205 mm.

Molds for forming potting portions were covered in both ends of the housing. A composition for forming the potting portions was injected into the caps and filled gaps between the hollow fibers, and then the composition was hardened, so as to seal the housing. After the caps were uncovered, the ends of the hollow fiber bundle were exposed by cutting the protruding end of the hardened potting portions. The hollow fiber module was manufactured by caps having a fluid port was covered in both ends of the housing.

### Example 1

A pair of hollow fiber bundles respectively having 7,000 pieces of polysulfone hollow fibers (external diameter: 900 um, internal diameter: 800 um) were mounted in a housing (width: 250 mm, length: 250 mm, height: 500 mm). Herein, the fluid penetration distance was 60 mm.

Molds for forming potting portions were covered in both ends of the housing. A composition for forming the potting portions was injected into the caps and filled gaps between the hollow fibers, and then the composition was hardened, so as to seal the housing. After the caps were uncovered, the ends of the hollow fiber bundle were exposed by cutting the protruding end of the hardened potting portions. The hollow fiber module was manufactured by caps having a fluid port was covered in both ends of the housing.

### Example 2

Three hollow fiber bundles respectively having 4,666 pieces of polysulfone hollow fibers (external diameter: 900 um, internal diameter: 800 um) were mounted in a housing (width: 250 mm, length: 250 mm, height: 500 mm). Herein, the fluid penetration distance was 40 mm.

Molds for forming potting portions were covered in both ends of the housing. A composition for forming the potting portions was injected into the caps and filled gaps between the hollow fibers, and then the composition was hardened, so as to seal the housing. After the caps were uncovered, the ends of the hollow fiber bundle were exposed by cutting the protruding end of the hardened potting portions. The hollow fiber module was manufactured by caps having a fluid port was covered in both ends of the housing.

### Example 3

Six hollow fiber bundles respectively having 1,555 pieces of polysulfone hollow fibers (external diameter: 900 um, internal diameter: 800 um) were mounted in a housing (width: 250 mm, length: 250 mm, height: 500 mm). Herein, the fluid penetration distance was 20 mm.

Molds for forming potting portions were covered in both ends of the housing. A composition for forming the potting portions was injected into the caps and filled gaps between the hollow fibers, and then the composition was hardened, so as to seal the housing. After the caps were uncovered, the ends of the hollow fiber bundle were exposed by cutting the protruding end of the hardened potting portions. The hollow fiber module was manufactured by caps having a fluid port was covered in both ends of the housing.

### Experiment Example

### Performance Analysis of the Manufactured Hollow Fiber Module

Dry air was supplied into the inside and the outside of the hollow fiber bundle respectively of the hollow fiber modules manufacturing the Examples and the Comparative Example. The gas-to-gas humidification was performed while the inside condition of the hollow fiber bundle was maintained at temperature 70° C., humidity 90 RH %, and the outside condition of the hollow fiber bundle was maintained at temperature 40° C., humidity 10 RH %.

A humidification performance is measured by calculating a dew point (° C.) of the humidified fluid when the humidified fluid was discharged from the inside of the hollow fibers. The dew point was calculated by measuring temperature and humidity of the humidified fluid. The results of the analysis are presented in the following Table 1.

TABLE 1

| | Comparative | | | |
|---|---|---|---|---|
| | Example | Example 1 | Example 2 | Example 3 |
| humidification | 48 | 56 | 58 | 53 |
| performance (° C.) | | | | |

According to the results of the above Table 1, it can be seen that the hollow fiber modules manufactured by Examples had an improved humidification performance compared to the hollow fiber module manufactured by Comparative Example.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### MODE FOR INVENTION

Various embodiments have been described in the best mode for carrying out the invention.

### INDUSTRIAL APPLICABILITY

The hollow fiber module of the present invention could be used as any one selected from the group consisting of a gas separating module, a heat exchanging module, a humidifying module and a water-treatment module.

The hollow fiber module may maximize the fluid delivery efficiency by improving the flow uniformity of the fluid flowing the outside of the hollow fibers. In addition, the hollow fiber module may minimize the additional usage of the hollow fibers, and thus the cost and the size of the hollow fiber module may be reduced.

1. A hollow fiber module comprising:
a housing, and
a hollow fiber bundle mounted in the housing and having a fluid penetration distance ranged from 10 to 200 mm,
wherein the fluid penetration distance means the shortest distance from the outmost hollow fiber in a cross-section of the hollow fiber bundle to the hollow fiber existing at the center in the cross-section of the hollow fiber bundle.

2. The hollow fiber module according to claim 1, wherein the ratio of the fluid penetration distance to the length of the hollow fiber bundle is in the range of 5 to 100%.

3. The hollow fiber module according to claim 1, wherein the hollow fiber bundle has a wide and flat shape.

4. The hollow fiber module according to claim 3, wherein the thickness of the hollow fiber bundle is in the range of 20 to 400 mm.

5. The hollow fiber module according to claim 3, wherein the ratio of the thickness to the width is in the range of 10 to 100%.

6. The hollow fiber module according to claim 1, wherein the hollow fiber bundle comprises the hollow fibers in the amount of 30 to 60 vol % relative to the total volume of the hollow fiber bundle.

7. The hollow fiber module according to claim 1, comprising a plurality of the hollow fiber bundles and a barrier dividing the hollow fiber bundles.

8. The hollow fiber module according to claim 7, comprising a plurality of the barriers, and the barrier is disposed to surround each of the hollow fiber bundle.

9. The hollow fiber module according to claim 7, wherein the barrier has through-holes.

10. The hollow fiber module according to claim 1, wherein the housing has a circular or an angular cross-sectional shape.

11. The hollow fiber module according to claim 1, wherein the housing is opened at both ends, and the housing has an inlet port and an outlet port.

12. The hollow fiber module according to claim 1, further comprising a potting portion fixing an end portion of the hollow fiber bundle to the housing and coupled to an end portion of the housing so as to hermetically seal the housing.

13. The hollow fiber module according to claim 1, further comprising a cover coupled to an end portion of the housing and having a fluid port.

14. The hollow fiber module according to claim 1, wherein the hollow fiber module is any one selected from the group consisting of a gas separating module, a heat exchanging module, a humidifying module and a water-treatment module.

15. The hollow fiber module according to claim 8, wherein the barrier has through-holes.
